(19) United States
(12) Patent Application Publication
(10) Pub. No.: US 2011/0232587 A1
(43) Pub. Date: Sep. 29, 2011

(54) Animal cooling device and method therefor

(75) Inventors: Richard C. Levy, Delray Beach, FL (US); Gregory S. Spiegel, Land of Lakes, FL (US)

(73) Assignee: Rose America Corporation

(21) Appl. No.: 12/659,875

(22) Filed: Mar. 24, 2010

(51) Int. Cl. A01K 27/00; F25D 31/00; B05B 9/03; B65D 25/40; A01K 29/00

(52) U.S. Cl. 119/796; 62/259.3; 239/375; 222/566; 119/174

(57) ABSTRACT

An animal cooling device includes a housing with front, rear, top, and bottom portions, a fluid container removably positioned adjacent the top portion of the housing, a nozzle disposed remotely from the cooling device for dispensing a fluid adjacent an animal, a length of tubing connecting the nozzle with the cooling device, and a pump for pressurizing the fluid. The housing includes a handle with a trigger for dispensing the fluid from the container.

### FIELD AND BACKGROUND OF THE INVENTION

The present invention is generally directed to animal accessories, and more particularly to a method and device for cooling an animal, such as a dog, cat, or other animal or pet.

Many animals, particularly the domesticated pets, are adversely affected by heat and high temperatures. More specifically, the bodies of the warm-blooded animals maintain thermal homeostasis; that is, their body temperature is maintained at a roughly constant level, regardless of the temperature of the surrounding environment. One way to maintain the body temperature is to cool down or regulate the metabolic rate.

Various animal accessory devices are available in the prior art, as shown in U.S. Pat. Nos./Publications Nos. 2,023,950; 5,501,179; 6,327,998; 7,152,902; 7,497,186; 2005/0217609; 2006/0012212; 2007/0261645; and 2008/0173257.

### ASPECTS OF THE INVENTION

The present disclosure is directed to various aspects of the present invention.

One aspect of the present invention includes a device for regulating the body temperature of an animal.

Another aspect of the present invention includes a device for cooling an animal, such as a dog, cat, or other animal or pet.

Another aspect of the present invention includes a device which can be used as a play or amusement device by an animal owner when playing or otherwise interacting with animals.

Another aspect of the present invention includes a device which can be used as a positive reinforcement tool by an animal owner to reward the animal for good behavior.

Another aspect of the present invention includes an animal cooling device, which includes a housing with front, rear, top, and bottom portions, a fluid container removably positioned adjacent the top portion of the housing, a nozzle disposed remotely from the cooling device for dispensing a fluid adjacent an animal, a length of tubing connecting the nozzle with the cooling device, and a pump for pressurizing the fluid. The housing includes a handle with a trigger for dispensing the fluid from the container.

Another aspect of the present invention includes an animal cooling device, which includes a housing with front, rear, top, and bottom portions, a fluid container removably positioned adjacent the top portion of the housing, a nozzle disposed remotely from the cooling device for dispensing a fluid adjacent an animal, a length of tubing connecting the nozzle with the cooling device, a pump for pressurizing the fluid, and a leash member including a first end connected to the cooling device and a second free end for detachably connecting to the animal. The leash member includes an internal recess for accommodating the tubing. The housing includes a handle with a trigger for dispensing the fluid from the container.

Another aspect of the present invention includes a method of cooling an animal, which includes providing a device including a housing with front, rear, top, and bottom portions, a fluid container removably positioned adjacent the top portion of the housing, a nozzle disposed remotely from the cooling device for dispensing a fluid adjacent an animal, a length of tubing connecting the nozzle with the cooling device, and a pump for pressurizing the fluid. The housing includes a handle with a trigger for dispensing the fluid from the container. The nozzle is positioned adjacent the animal and the trigger is activated to dispense the fluid onto the animal.

### BRIEF DESCRIPTION OF THE DRAWINGS

One of the above and other aspects, novel features and advantages of the present invention will become apparent from the following detailed description of a preferred embodiment(s) of the invention, as illustrated in the drawings, in which:

FIG. 1 is a perspective view of a preferred embodiment of an animal cooling device of the present invention, shown in use;

FIG. 2 is a partial enlarged perspective view of the cooling device of FIG. 1;

FIG. 3 is an enlarged perspective view of the cooling device of FIG. 2, shown without one-half cover to show the internal components;

FIG. 4 is a view similar to FIG. 3, shown with the container separate from the cooling device;

FIG. 5 is a perspective view of the end portion of the leash, showing a nozzle;

FIG. 6 is a sectional view taken along line 6-6 of FIG. 5;

FIG. 7 is an enlarged sectional view taken along line 7-7 of FIG. 5;

FIG. 8 is a partial enlarged view of the cooling device of FIG. 3, showing the trigger in a locked position;

FIG. 9 is a view similar to FIG. 8, showing the trigger in an unlocked position;

FIG. 10 is an enlarged sectional view taken along line 10-10 of FIG. 8, shown with both covers of the housing;

FIG. 11 is a view similar to FIG. 10, showing the unlocked position of the trigger shown in FIG. 9;

FIG. 12 is a view similar to FIG. 1, showing an alternate embodiment of the animal cooling device in accordance with the present invention; and

FIG. 13 is a view similar to FIG. 3, showing the alternate embodiment of the cooling device of FIG. 12.

### DETAILED DESCRIPTION OF THE PREFERRED EMBODIMENT(S) OF THE INVENTION

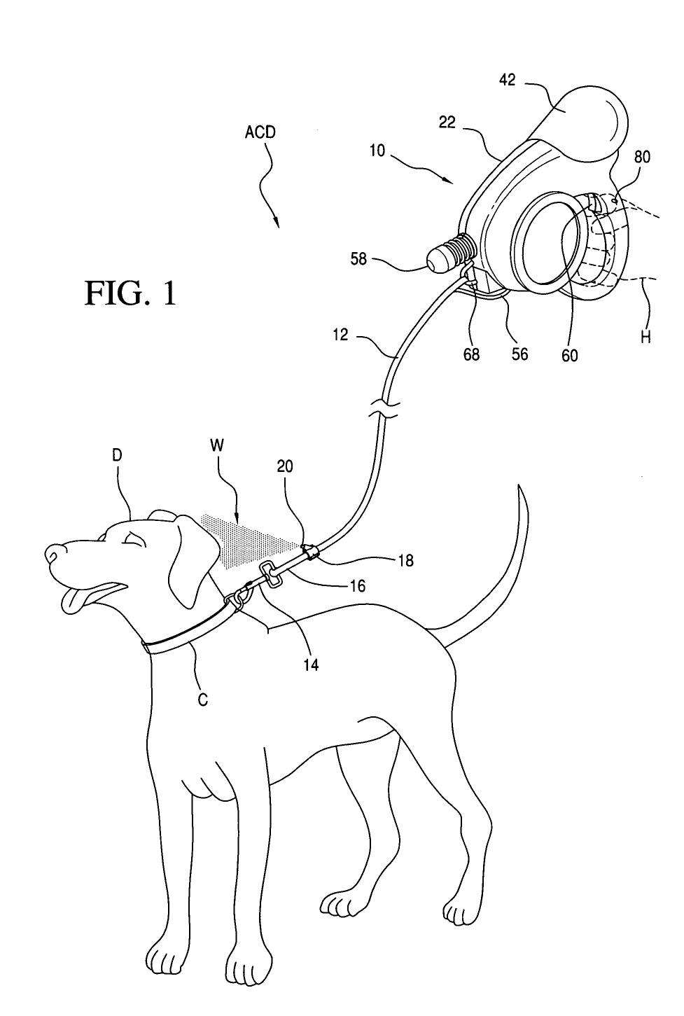

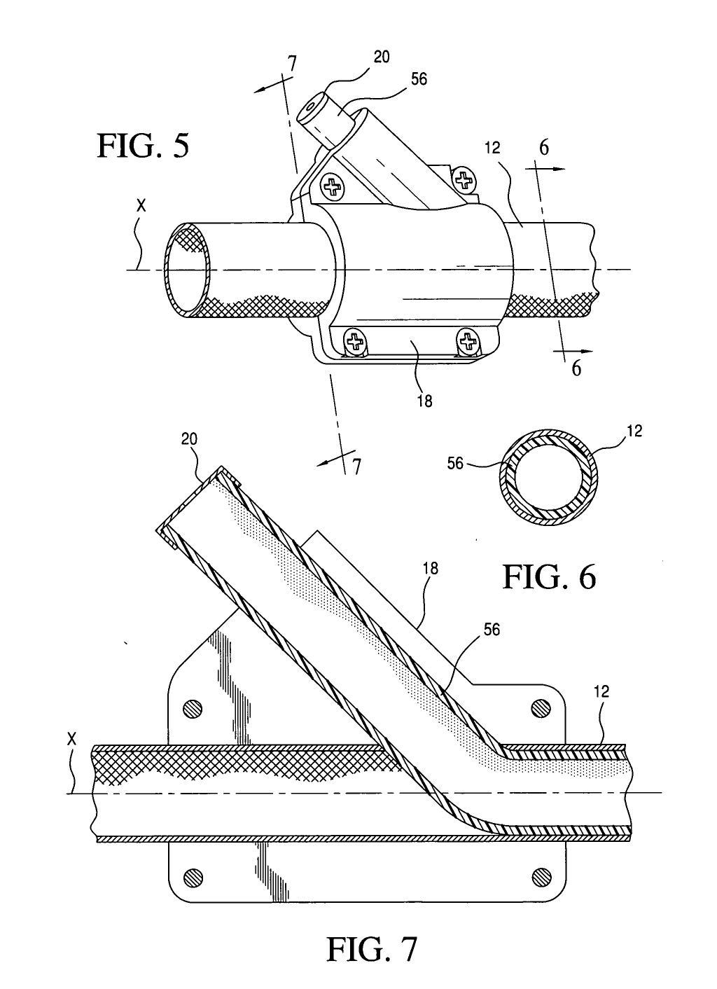

As best shown in FIG. 1, the animal cooling device ACD in accordance with a preferred embodiment of the invention, includes a housing 10 and a leash member 12 of a suitable length to be connected to an animal, such as a dog D. The leash member 12 includes a conventional snap clip 14 at its free end 16 for fastening the leash 12 to, for example, a collar C on the dog D. Positioned adjacent the free end 16 of the leash member 12, is a bracket 18 for supporting and orienting a nozzle 20 for dispensing a fluid, such as water W, therefrom onto the dog D (see FIGS. 1 and 5-7).

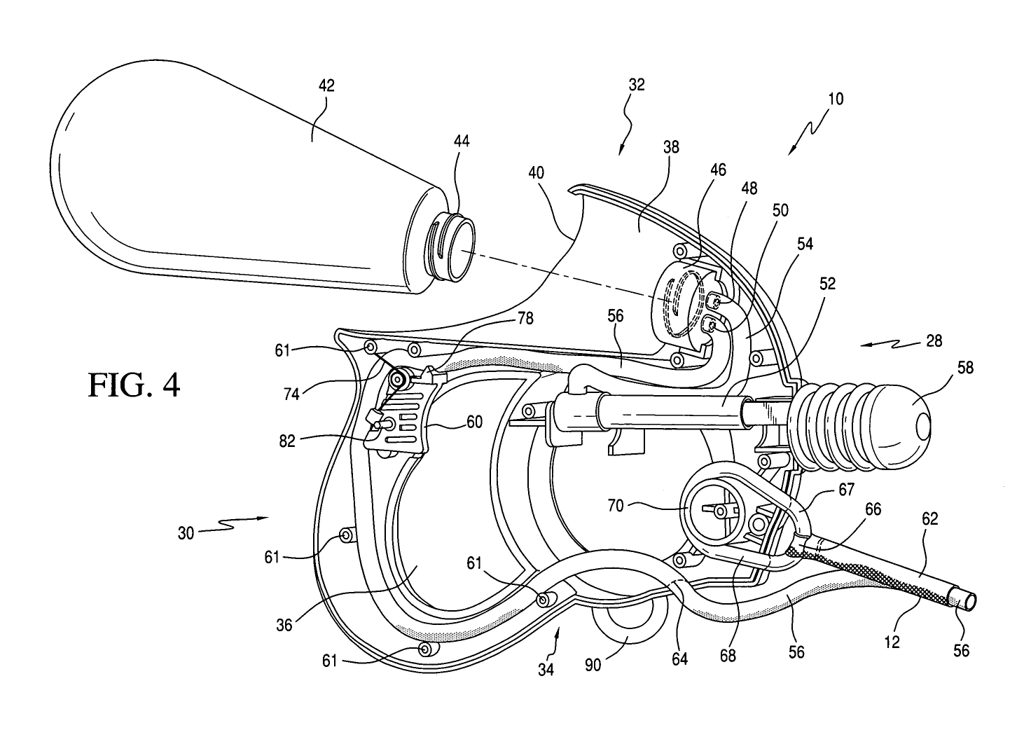

Preferably, the nozzle 20 is positioned short of the free end 16 and at an angle relative to the longitude axis X of the leash member 12 (see FIGS. 4-6). In particular, it is preferred that the nozzle 20 be positioned at least about four to about twelve inches from the free end 16. Likewise, it is preferred that the nozzle 20 be oriented at an angle of about 15° to about 90°. It is noted herewith that although the nozzle 20 has been shown to be fixed in a particular direction, it is within the scope of the invention to change the direction or use different types of nozzle that may, for example, pivot, rotate or swivel. In the same manner, it is noted herewith that other types of nozzles, that dispense fluids in different patterns, with or without speed or intensity adjustment, may be used.

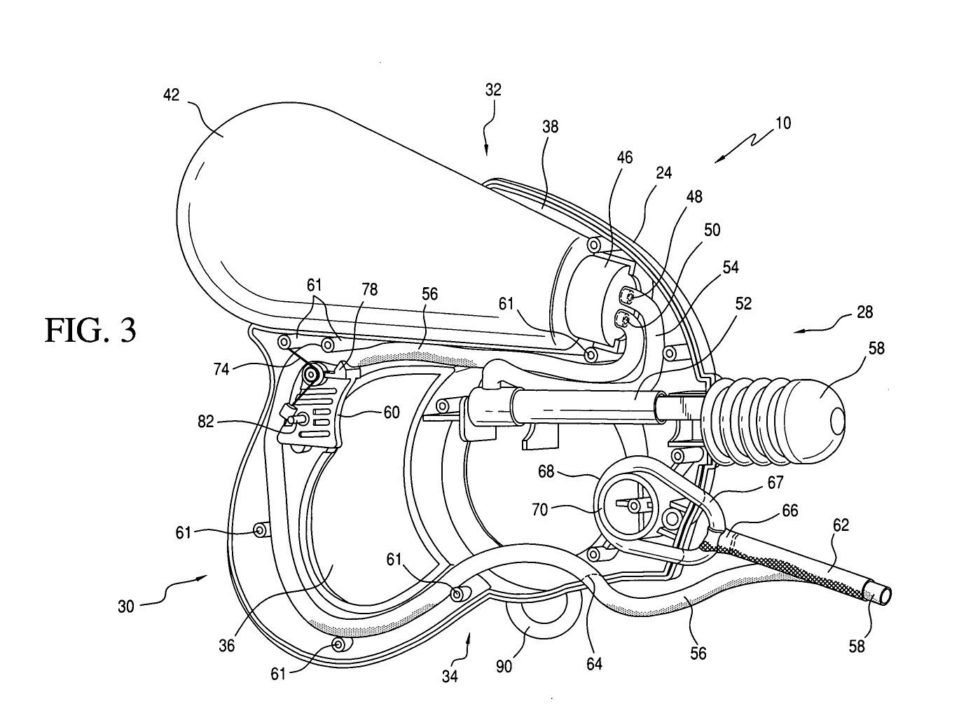

As best shown in FIGS. 1-4, the fluid dispensing assembly 10 is in the form of a housing 22, preferably composed of two molded rigid shells 24 and 26, mechanically fastened together to encase various components. (It is noted that shell 26, which is similar in construction to shell 24, is omitted from FIGS. 3-4.) The housing 22 includes a front section 28, a rear section 30 in the form of a handle, a top section 32, and a bottom section 34. A gap 36 between the front and rear sections 28 and 30, allows a user to grasp or hold the fluid dispensing assembly 10 by hand H.

As best shown in FIGS. 3-4, a generally horizontal recess 38 extends into the housing 22, from about the rear handle section 30 towards the front 28 thereof. The recess 38 includes an opening 40 to allow insertion or removal of a container 42 into the housing 22. The container 42 is preferably conical in shape and includes a threaded neck portion 44 to be fastened to a threaded cap 46 mounted within the housing 22.

The cap 46 includes nipples 48 and 50 that allow the container 42 to be in fluid communication with a manually operable pump 52 and the nozzle 20, via tubes 54 and 56, respectively. Preferably, the pump 52 is a compression pump that can be used to pressurize the fluid inside the container 42, by repeatedly pushing on an actuator 58 positioned in the front section 28 of the housing 22. As best shown in FIGS. 3-4, the tube 56 is guided from the nipple 50 towards the rear handle section 30, past a trigger 60, and then to the front section 28, by various guide tabs 61. The tube 56 exits the fluid dispensing assembly 10 via an opening 64, to be incorporated inside of a sheath 62. As best shown in FIGS. 1 and 7, the tube 56 runs inside the sheath 62 (leash 12) until adjacent or short of the free end 16 thereof, where it exits to be connected to the nozzle 20.

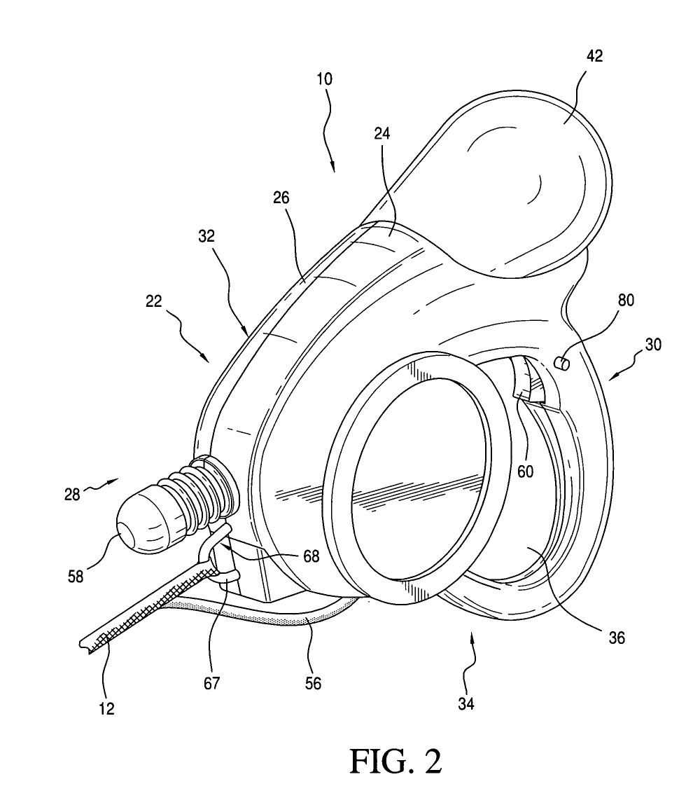

The sheath 62 is preferably made of a durable braided material of a sufficient strength to hold or restrain an animal and functions as leash 12. The end 66 of sheath 62 is tightly anchored at a front portion 67 of a rigid loop 68, which is secured in the housing 22 about a cylinder 70. As more clearly shown in FIG. 2, the front portion 67 of the loop 68 lies outside the housing 22.

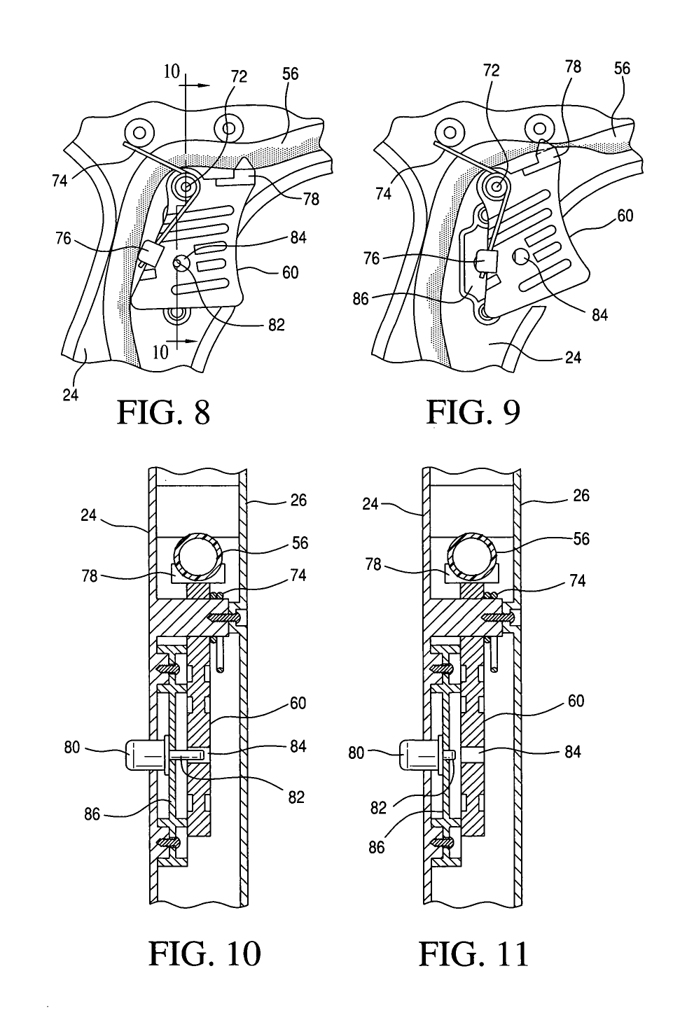

Referring to FIGS. 8-11, the trigger 60 is pivotally mounted at 72 and is biased by a spring 74 at a section 76 thereof. The trigger 60 includes a crimp member 78 for pinching the tube 56, to thereby restrict or stop the flow of the fluid therein (see FIGS. 9 and 11). When the trigger 60 is pulled against the force of the spring 74, the crimp section 78 releases the tube 56, to thereby allow the fluid to flow therein (see FIGS. 8 and 10). When the animal cooling device ACD is not in use, it is preferred that the trigger 60 be kept in the pulled position, shown in FIGS. 8 and 10, to prevent or significantly reduce permanent crimping or damaging of the tube 56. In order to accomplish this objective, a spring-loaded push-button 80 allows a lock pin 82 to selectively pass through a hole 84 in the trigger 60. Therefore, as shown in FIGS. 8 and 10, when the lock pin 82 extends into the hole 84, the trigger 60 is held in place and cannot be pulled or moved. On the other hand, as shown in FIGS. 9 and 11, when the lock pin 82 is retracted from the hole 84, the trigger 60 is free to be pulled against the force of the spring 74, or released. As best shown in FIGS. 10-11, the push button 80 is supported on a plate 86 in the shell 24.

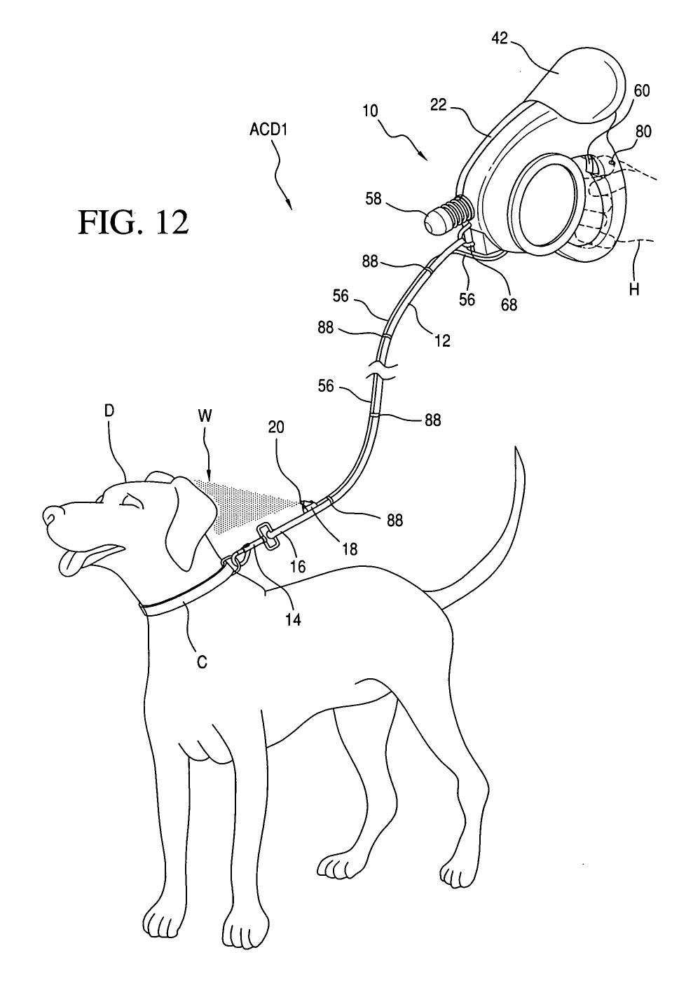

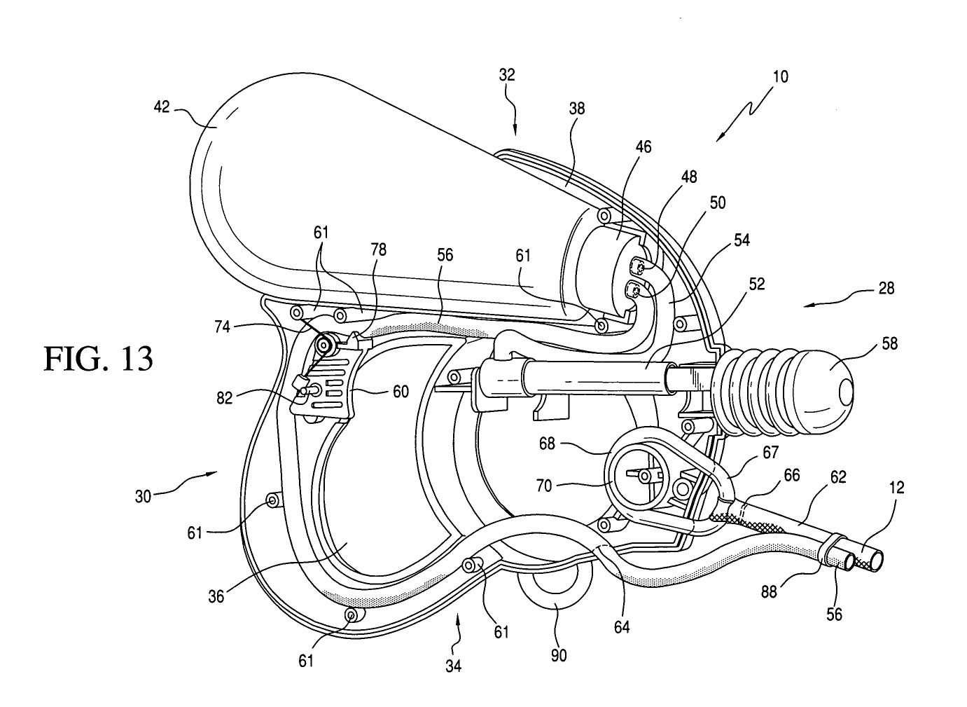

An alternate embodiment of the animal cooling device ACD1 of the present invention will now be described by referring to FIGS. 12-13, where like components have been designated by the same reference numerals. The alternate embodiment shown in FIGS. 12-13, is identical to the embodiment shown in FIGS. 1-11, with the exception that the tube 56 runs outside the leash 12 and is fastened thereto by using, preferably elastic fasteners 88, along the lengths thereof.

Although the leash 12 has been shown to be fixedly anchored at the loop 68, it is noted that the alternate embodiment can be produced without any leash so that the animal cooling device ACD1 is used or retrofitted with any conventional leash. In other words, if a user already has a leash, the user's leash could simply be used with an embodiment of the animal cooling device shown in FIGS. 12-13, but without the leash 12, by simply running the tube 56 along the user's leash. With respect to the end of the user's leash, lying adjacent the fluid dispensing assembly 10, the user can simply hold it in hand or, for example, clip it to his/her belt.

As best shown in FIGS. 3-4 and 13, a ring 90 is provided in the bottom section 34 to allow a user to fasten the clip 14 thereto for storage purposes, or when not using the cooling device.

By using any of the embodiments described above (or other that fall within the scope of the present invention), a user would be able to hydrate or cool an animal, such as dog D, by dispensing water thereon. This would not only help cool or hydrate the animal, but also amuse or impart fun, both for the user and the animal. Thus, the animal cooling device of the invention can be used for maintaining health, as well as for playful purposes.

While this invention has been described as having preferred sequences, ranges, steps, materials, structures, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention.

What is claimed is:

1. An animal cooling device, comprising:
a) a housing including front, rear, top, and bottom portions;
b) a fluid container removably positioned adjacent the top portion of said housing;
c) said housing including a handle with a trigger for dispensing a fluid from said container;
d) a nozzle disposed remotely from the cooling device for dispensing the fluid adjacent an animal;
e) a length of tubing connecting said nozzle with the cooling device; and
f) a pump for pressurizing the fluid.

2. The device of claim 1, wherein:
a) said housing includes a top opening extending from adjacent the rear portion of said housing toward the front portion thereof;
b) said fluid container includes top and bottom sections;
c) the top section of said fluid container is received in the top opening of said housing.

3. The device of claim 2, wherein:
a) the bottom section of said fluid container is oriented upwardly and extends beyond the top opening.

4. The device of claim 2, wherein:
a) the top section of said fluid container is narrower in diameter than the bottom section.

5. The device of claim 1, wherein:
a) said tubing extends into the cooling device and is releasably connected to said fluid container.

6. The device of claim 5, wherein:
a) said tubing extends past the trigger in said handle;
b) said trigger includes a crimp member for pinching said tubing.

7. The device of claim 1, wherein:
a) said pump includes a manually operable actuator.

8. The device of claim 7, wherein:
a) said actuator is positioned externally in the front portion of said housing.

9. The device of claim 1, wherein:
a) said nozzle is oriented in a manner so as to dispense the fluid at an angle relative to the adjacent end of said tubing.

10. The device of claim 9, wherein:
a) the angle comprises about 15° to about 90°.

11. The device of claim 1, wherein:
a) said nozzle is positioned at least about 4 to about 12 inches from the animal collar.

12. The device of claim 1, in combination with a leash.

13. An animal cooling device, comprising:
a) a housing including front, rear, top, and bottom portions;
b) a fluid container removably positioned adjacent the top portion of said housing;
c) said housing including a handle with a trigger for dispensing a fluid from said container;
d) a nozzle disposed remotely from the cooling device for dispensing the fluid adjacent an animal;
e) a length of tubing connecting said nozzle with the cooling device;
f) a pump for pressurizing the fluid;
g) a leash member including a first end connected to the cooling device and a second free end for detachably connecting to the animal; and
h) said leash member including an internal recess for accommodating said tubing.

14. The device of claim 13, wherein:
a) said tubing includes first and second ends in fluid communication with said container and said nozzle, respectively.

15. The device of claim 14, wherein:
a) said nozzle is positioned short of the second free end of said leash member.

16. The device of claim 14, wherein:
a) said nozzle is positioned about 4 to about 12 inches from the second free end of said leash member.

17. The device of claim 14, wherein:
a) said nozzle is oriented at an angle of about 15° to about 90° relative to the second free end of said leash member.

18. The device of claim 14, wherein:
a) said nozzle is oriented at an angle of about 45° relative to the second free end of said leash member.

19. The device of claim 13, wherein:
a) said pump includes an actuator positioned generally diametrically opposite to said handle.

20. The device of claim 13, wherein:
a) said housing comprises two half shells made of a generally rigid material.

21. A method of cooling an animal, comprising the steps of:
a) providing a device, comprising:
i) a housing including front, rear, top, and bottom portions;
ii) a fluid container removably positioned adjacent the top portion of said housing;
iii) said housing including a handle with a trigger for dispensing a fluid from the container;
iv) a nozzle disposed remotely from the cooling device for dispensing the fluid adjacent an animal;
v) a length of tubing connecting the nozzle with the cooling device; and
vi) a pump for pressurizing the fluid;
b) positioning the nozzle adjacent the animal;
c) activating the trigger to thereby dispense the fluid onto the animal.

22. The method of claim 21, further comprising the steps of:
filling the container with water prior to positioning on the housing; and
pressurizing the water by activating the pump after positioning the container on the housing.

23. The method of claim 21, further comprising the steps of:
fastening the tubing to a leash; and
positioning the nozzle about 4 to about 12 inches from the end of the leash lying adjacent the animal.
